(19) United States
(12) Patent Application Publication
(10) Pub. No.: US 2019/0079554 A1
(43) Pub. Date: Mar. 14, 2019

(54) METHOD AND APPARATUS FOR DETERMINING AN OUTPUT VALUE REPRESENTING A PICTURE DATA BY APPLYING A PIECE-WISE LINEAR FUNCTION ON AN INPUT DATA REPRESENTING A PICTURE DATA

(71) Applicant: THOMSON Licensing, Issy-les-Moulineaux (FR)

(72) Inventors: Franck GALPIN, Thorigne-Fouillard (FR); Fabrice LE LEANNEC, Mouaze (FR); Edouard FRANCOIS, Bourg des Comptes (FR)

(21) Appl. No.: 15/765,636

(22) PCT Filed: Sep. 29, 2016
(86) PCT No.: PCT/EP2016/073318

§ 371 Date: Apr. 3, 2018

(30) Foreign Application Priority Data
Oct. 5, 2015 (EP) 15306561.0

(51) Int. Cl. G06F 1/03; G06F 7/556; G06F 17/12

(52) U.S. Cl. CPC G06F 1/0307; G06F 17/12; G06F 7/556

(57) ABSTRACT

A method and apparatus for determining an output value representing a picture data by applying a piece-wise linear function on an input value representing a picture data, said piece-wise linear function comprising at least one piece characterized by a slope value ai, an offset value and an interval defined over a range of values comprised between a lower bound and an upper bound. The method comprises: —obtaining (50) a coded input value X coded with quantization on n bits; —obtaining (51) a coded slope value Ai, said coded slope value Ai representing a mantissa value ai_m coded with m bits and an exponent of 2 value ai_e coded with (K−m) bits, K being the total number of bits to code said slope value ai; —identifying the (K−m) most significant bits of the coded slope, said (K−m) most significant bits forming an exponent value ai_e of a decoded slope value; —identifying the m least significant bits of the coded slope value, said m least significant bits forming the mantissa ai_m of the decoded slope value; —determining (52) the output value y by shifting the product of the mantissa ai_m of the decoded slope and the coded input data X by an integer value equal to (n+m−ai_e−p).

### FIELD

The present principles generally relate to coding/decoding of functions intended to be transmitted, as part, for example, of a SEI or PPS message, in order to apply the function at decoder side using a bit exact process. Especially, it deals with representation of functions with large variation of the first order derivative.

### BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

We need to code and send to a decoder a mono-dimensional function f. This function f can, for instance, be intended to be applied on pixel values. An example is a function f intended to be applied to a chroma correction on U and V components of a color picture in the following shape:

Uᵣ=f(Y)*U

Vᵣ=f(Y)*V

In this example, we assume the same function f applies on chroma components U and V and f depends on the luma component Y. We also assume a great accuracy is needed in the representation of the function f.

In order to code this function f, several methods are already available. The most straightforward method is to determine a LUT (Look-Up-Table) representing the function f on the desired interval and to transmit this LUT to the decoder.

Mathematically speaking, a value of the LUT is given by: LUT[x]=Q(f(x)) where the size of the LUT depends on a given accuracy, missing values are reconstructed for example by interpolation between existing elements. he Q(.) function codes the values of the LUT typically, by: Q(x)=Int(x*Q) for fix-point representation where the operator Int(x) returns the closest integer value of input data x and Q is a quantization step.

Another method for coding the function f is to approximate said function f by a piece-wise polynomial (PWL) model and to code the parameters of this piece-wise polynomial model. A usual piece-wise linear model comprises at least one piece on which an approximation function of the shape ai*x+bi is defined over an interval Rᵢ itself defined over a range of values comprised between a lower bound mᵢ and an upper bound Mᵢ. The parameter value ai, usually called the scale factor or slope value, and the parameter bi, usually called the offset value, have to be coded for each piece. The N intervals of a PWL model can be uniform or non-uniform.

For the first interval R₀ defined over a range of values comprised between a lower bound m₀ and an upper bound M₀, the approximate function is defined from a slope value a₀ and an offset value b₀.

For any other interval Rᵢ defined over a range of values comprised between a lower bound mᵢ and an upper bound Mᵢ, the approximate function is defined from a slope value aᵢ and an offset value bᵢ.

Assuming a C0 continuous at each bound of each interval, the number of values to be coded can be reduced by 1 for each interval, a slope value ai, plus an offset value b₀ for the first interval and an offset value b_{N-1} for the last interval. The offset value bi (i≠0 and i≠N−1) of each piece is derived from the other slope and offset values by: bᵢ=(aᵢ₋₁−aᵢ)*Mᵢ₊₁+bᵢ₋₁

Then, only the values b₀, b_{N-1}, aᵢ and the length of each range Mᵢ-mᵢ i=0, . . . N−1, of the piece-wise linear model have to be coded.

An illustration of this model is shown in FIG. 1, with N=4 pieces.

The piece-wise linear (PWL) model can be extended to polynomial representation and the C0 continuity to higher order continuity as well.

Each parameter of the PWL model is coded using an integer representation for bit exact constraint.

Assuming a fix-point representation, a typical decoder operation to calculate an output value y for an input value x from the function f represented by a PWL model comprises:
determining an interval Ri by determining in which range the input value x belongs; for example x is in the range [mᵢ,Mᵢ];
computing the output value y by:

y=(Aᵢ*X+Bᵢ)>>Q (1)

where
X is the coded input value x given by Int(x*Qₓ) where Qₓ=2ⁿ if X is coded with quantization on n bits;
Aᵢ is the coded slope value ai given by Int(aᵢ*Qₐᵢ) where Qₐᵢ=2^{m} if Aᵢ is coded with quantization on m bits;
Bᵢ is the coded offset value bi given by Int(bᵢ*Q_{bi}) where Q_{bi}=2^{n+m};
p is the number of quantization bits used to code the output value y and
Q is a quantization step equals to n+m−p.

The operators “<<” and “>>” correspond to the well-known left and right shifting of a binary representation.

Note that the equation (1) can be more generically written as:

y=((Aᵢ*X)>>Q)+(Bᵢ>>Q1) (2)

where Q1 is a quantization step used for quantizing bᵢ (same as O_{bi}).

Since the quantization accuracy issue mostly concerns the slope values aᵢ, for sake of simplification, the offset values bᵢ will be considered as already derived, and the following equation is used as reference

y=((Aᵢ*X)>>Q)+bᵢ (3)

where bᵢ is quantized with p bits.

A typical problem arising using these coding methods is when the slope value has very large variations, with non-monotonic functions, and slope values than can be very close to 0 or of very high values. It is not possible to keep enough accuracy, either on the small values of the slope, or on the large values of the slopes, without using a large number of bits to represent the fix-point values of the slope and offset values to code. This is problematic for software and hardware-friendly implementations.

The present principles aim at solving these issues, by using different adaptations to code the slope and offset values of the piece-wise model.

### SUMMARY

The following presents a simplified summary of the present principles in order to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles set out to remedy at least one of the drawbacks of the prior art with a method for determining an output value representing a picture data by applying a piece-wise linear function on an input value representing a picture data, said piece-wise linear function comprising at least one piece characterized by a slope value aᵢ, an offset value and an interval defined over a range of values comprised between a lower bound and an upper bound. The method comprises:
obtaining a coded input value X coded with quantization on n bits;
obtaining a coded slope value Ai, said coded slope value Ai representing a mantissa value ai_m coded with m bits and an exponent of 2 value ai_e coded with (K−m) bits, K being the total number of bits to code said slope value ai;
identifying the (K−m) most significant bits of the coded slope, said (K−m) most significant bits forming an exponent value aᵢ_{_}e of a decoded slope value;
identifying the m least significant bits of the coded slope value, said m least significant bits forming the mantissa aᵢ_{_}m of the decoded slope value;
determining the output value y by shifting the product of the mantissa aᵢ_{_}m of the decoded slope and the coded input data X by an integer value equal to (n+m−aᵢ_{_}e−p).

According to other of their aspects, the present principles relate to a device comprising means configured to implement the above method, a computer program product comprising program code instructions to execute the steps of the above method when this program is executed on a computer, a processor readable medium having stored therein instructions for causing a processor to perform at least the steps of the above method, and a non-transitory storage medium carrying instructions of program code for executing steps of the above method when said program is executed on a computing device.

The specific nature of the present principles as well as other objects, advantages, features and uses of the present principles will become evident from the following description of examples taken in conjunction with the accompanying drawings.

### BRIEF DESCRIPTION OF DRAWINGS

In the drawings, examples of the present principles are illustrated. It shows:

FIG. 1 shows an illustration of a representation of a piece-wise linear function;

FIG. 2 shows an illustration of representation of a piece-wise linear function;

FIG. 3 shows an example of an architecture of a device in accordance with an example of present principles;

FIG. 4 shows two remote devices communicating over a communication network in accordance with an example of present principles;

FIG. 5 shows a diagram of the steps of the method in accordance with the present principles;

Similar or same elements are referenced with the same reference numbers.

### DESCRIPTION OF EXAMPLE OF THE PRESENT PRINCIPLES

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as“/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims.

While not explicitly described, the present examples and variants may be employed in any combination or sub-combination.

The present principles are described for determining an output value representing a picture data by applying a piece-wise linear function on an input value representing a picture data. Said piece-wise linear function comprising at least one piece characterized by a slope value, an offset value and an interval Ri defined over a range of values comprised between a lower bound and an upper bound. The principles can apply to others types of scalar data.

In the following, it is considered that the interval Ri is previously determined from an input value x. The interval Ri is defined over a range of values comprised between a lower bound mᵢ and an upper bound Mᵢ. The piece of the piece-wise linear model is defined over the interval Ri from a slope value as and an offset value bᵢ deduced as follows: bᵢ=(aᵢ₋₁−aᵢ)*Mᵢ₋₁+bᵢ₋₁. From a coded slope Aᵢ, a decoder deduces a decoded slope value aᵢ, and the decoded slope value aᵢ is then used to compute the output value of y=f(x).

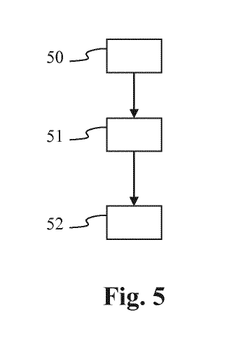

According to a first embodiment, illustrated in FIG. 5, a slope value a is coded using a log 2 representation. Instead of coding the slope value itself, what is coded is the slope value a multiplied by R=2^{m}, where R is the closest value, of the shape of power of 2 (2^{m}), larger than or equal to the value (Mᵢ−mᵢ).

Ai=Int(aᵢ*R)=Int(aᵢ*2^{m}) (4)

Mathematically speaking, the value m is a non-fixed value deduced from the length of the interval Ri by m=Int(log 2(Mᵢ−mᵢ)).

According to this first embodiment, the method for determining an output value y representing a picture data then comprises:
obtaining (50) a coded input value X coded with quantization on n bits;
obtaining (51) a coded slope value Aᵢ coded with quantization on m bits, said coded slope value A representing the product of said slope value aᵢ by the closest value R, of the shape power of 2 (2^{m}), larger than or equal to the length of the interval Ri which the input value belongs to;
determining (52) the output value by shifting the product of the coded slope value A and the coded input data X by an integer value equal to (n+m−p), where p is the number of quantization bits used to code the output value y and adding an offset value bᵢ.

The output value y is then determined as follows:

y=((Aᵢ*X)>>(n+m−p))+bᵢ (5)

The advantage of this first embodiment of the method is that what is coded is a number in the range of the function f(x) modeled by the piece-wise linear mode, instead of in the range of its first-order derivative f′(x) (indeed slopes corresponds to first-order derivatives of the function f(x)).

Note that coding the input value x with quantization on n bits consists in calculating X=Int(x*2ⁿ), coding an output value with quantization on p bits consists in Y=Int(y*2^{p}) and coding a slope with quantization on m bits consists in Ai=Int(ai*2^{m}), n, m and p being integer values.

According to a variant of this first embodiment, the strategy for coding the slope value aᵢ is adapted to its value:
if aᵢ<1, then Aᵢ=Int(aᵢ*(1<<n))
if aᵢ>1, then Aᵢ=Int((1/aᵢ)*(1<<n)).

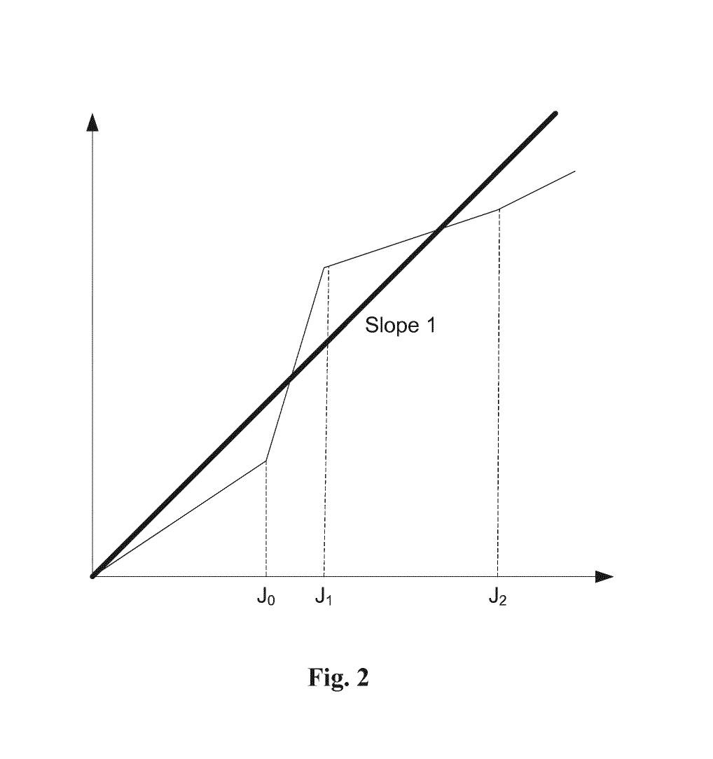

To detect at a decoder how the slope value has been coded, the points of the function for which the slope values become lower or larger than 1, are also coded. This is illustrated in FIG. 2, where points J0, J1 and J2 are coded to inform the decoder that changes appear at those positions.

In addition, the initial slope category (slope>1 or slope<1), named slope0_category, must be signaled to the decoder.

So in addition to the piece-wise model parameters (slope and offset values) signaled to the decoder, the following information have also to be signaled:
slope0_category
signaling the ending point of a current interval when a changing point occurs, i.e. the slope value of a following interval become greater to 1 and the slope value of the current interval is lower than 1; or the slope value of a following interval become lower than 1 and the slope value of the current interval is greater to 1.

For example, a number NC of changing points and a set of changing points Ji, for i=0 . . . NC−1 are signaled.

Hence, the decoder will be able for each segment [Ji,Ji+1] to know if this segment corresponds to a slope value below 1 or above 1.

Note that this process requires a division at decoder side, in case the slope is lower than 1.

The advantage of the first variant is no exponent is required compared to a second embodiment of the method described later.

In summary, the variant of the first embodiment comprises:
identifying the segment [Ji,Ji+1] which the input value x belongs to
identifying the slope_type of the segment [Ji,Ji+1]
if slope_type “ai<1”,

Ai=Int(ai*(1<<m))

ai=Ai/(1<<m)

y=((Aᵢ*X)>>(n+m−p))+bᵢ (6)
if slope_type “ai>=1”,

Ai=Int((1/ai)*(1<<m)).

ai=1/Ai/(1<<m)

y=((1/Aᵢ*X)>>(n+m−p))+bᵢ (7)

According to a second embodiment of the method, the slope value aᵢ is coded using a representation inspired from the floating-point representation. The coding of the slope value aᵢ uses a fix-length representation of K bits.

The floating-point representation consists in splitting a binary number into two parts, as follows: e₁e₂e₃ma₁ma₂ma₃ma₄ma₅ where eᵢ correspond to the bits of the exponent part of the number, and maᵢ correspond to the mantissa part of the number.

The number “e₁e₂e₃” in binary representation is the exponent e.

The number “ma₁ma₂ma₃ma₄ma₅” in binary representation is the mantissa ma.

In this example, 3 bits are used for the exponent, and 5 for the mantissa.

And the output value is computed as:

y=2^{e}*(1+ma/2^{M})=2^{e}+ma/2^{M-e} (8)

where e is the exponent, and ma the mantissa.

This second embodiment is an adaptation of the floating-point representation that consists in representing the coded slope Aᵢ as:

Aᵢ=aᵢ_{_}m*2^{ai}^{_}^{e}=aᵢ_{_}m*(1<<aᵢ_{_}e)=aᵢ_{_}m<<aᵢ_{_}e (9)

with aᵢ_{_}m being the mantissa and aᵢ_{_}e being the exponent.

The K bits are split into m bits for the mantissa and (K−m) bits for the exponent. K and m are predefined fixed parameters.

For an input value x corresponding to an interval Ri associated with a slope value aᵢ, the output value yᵢ is computed as follows:

y=((Aᵢ*X)>>(n+m−p)+bᵢ (10)

which can also be written as:

y=(aᵢ_{_}m*2^{ai}^{_}ₑ*X)>>(n+m−p)+bᵢ (11)

Actually, to keep a high accuracy depending on the exponent, equation (11) is replaced by the following:

y=(aᵢ_{_}m*X)>>(n+m−aᵢ_{_}e−p)+bᵢ (12)

that is equivalent to

y=(aᵢ_{_}m*X)/2^{(n+m-ai}^{_}^{e-p)}+bᵢ (13)

Thanks to this process, the accuracy obtained for the output value y is adapted to the amplitude of the slope value.

In summary, this second embodiment of the method for determining an output value y representing a picture data then comprises:
1. obtaining (50, FIG. 5) a coded input value X coded with quantization on n bits;
2. obtaining (51) a coded slope value Ai. Said coded slope value Ai representing a mantissa value ai_m coded with m bits and an exponent of 2 value ai_e coded with (Km) bits, K being the total number of bits to code a slope value aᵢ;
3. identifying the (K−m) most significant bits of the coded slope value Ai, said (K−m) most significant bits forming an exponent value aᵢ_{_}e of a decoded slope value;
   this can be done as aᵢ_{_}e=Aᵢ>>(K−m)
4. identifying the m least significant bits of the coded slope Ai, said m least significant bits forming the mantissa aᵢ_{_}m of the decoded slope value;
   this can be done as aᵢ_{_}m=Aᵢ−(Ai>>(K−m))<<(K−m)
6. determining (52) the output value y by shifting the product of the mantissa aᵢ_{_}m of the decoded slope value and the coded input data X by an integer value equal to (n+m−aᵢ_{_}e−p),

y=(aᵢ_{_}m*X)>>(n+m−aᵢ_{_}e−p)+bᵢ (14)

The first embodiment is actually a sub-case of this second embodiment (cf equations (4) and (9)). In first embodiment, an approximation of ai can be obtained from Int(ai*2^{m})/2^{m}, with m depending on the length of the segment Ri. In second embodiment, an approximation of ai can be obtained from Int(ai*2^{ai}^{_}^{e})/2^{ai}^{_}^{e}, and ai_e is non-fixed.

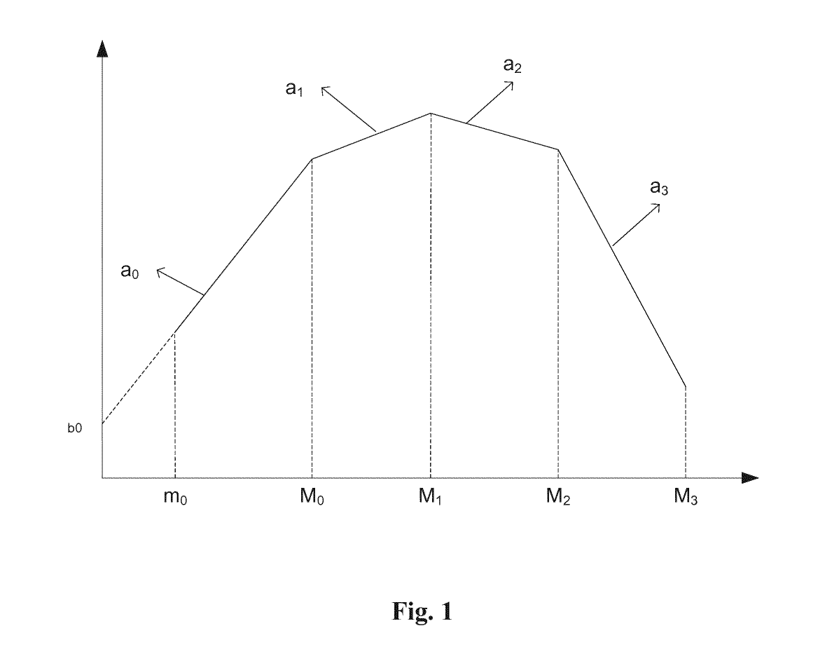

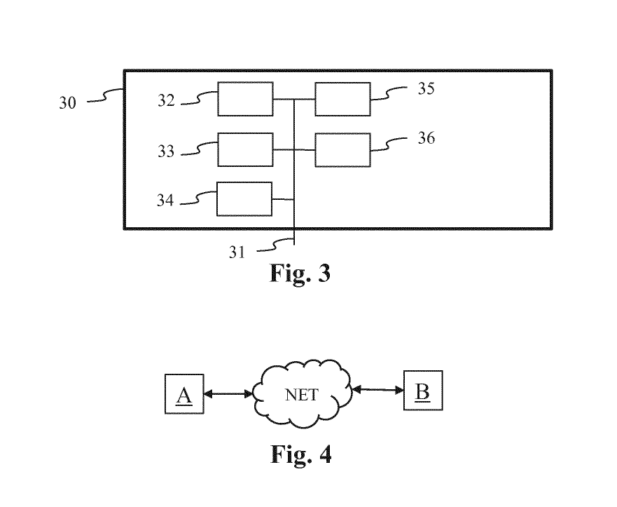

FIG. 3 represents an exemplary architecture of a device 30 which may be configured to implement a method described in relation with FIG. 1-2.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
an I/O interface 35 for reception of data to transmit, from an application; and
a battery 36

In accordance with an example, the battery 36 is external to the device. In each of mentioned memory, the word «register» used in the specification can correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

RAM 64 comprises, in a register, the program executed by the CPU 32 and uploaded after switch on of the device 30, input data in a register, intermediate data in different states of the method in a register, and other variables used for the execution of the method in a register.

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, device 30 being configured to implement a method described in relation with FIG. 1-2, belongs to a set comprising:
a mobile device;
a communication device;
a game device;
a tablet (or tablet computer);
a laptop;
a still picture camera;
a video camera;
an encoding chip;
a still picture server; and
a video server (e.g. a broadcast server, a video-on-demand server or a web server).

According to an example of the present principles, illustrated in FIG. 4, in a transmission context between two remote devices A and B over a communication network NET, the device A comprises a processor in relation with memory RAM and ROM which are configured to implement the coding part of a method as described in relation with the FIG. 1 or 2 and the device B comprises a processor in relation with memory RAM and ROM which are configured to implement which are configured to implement the decoding parts of a method as described in relation with FIG. 1 or 2.

In accordance with an example, the network is a broadcast network, adapted to broadcast still pictures or video pictures from device A to decoding devices including the device B.

A signal, intended to be transmitted by the device A. This signal comprises an information data indicating piece-wise parameters as explained above. In addition, the signal may further comprises:
slope0_category
the number NC of changing points
the set of changing points Ji, for i=0 . . . NC−1

Additionally, the methods may be implemented by instructions being performed by a processor, and such instructions (and/or data values produced by an implementation) may be stored on a computer readable storage medium. A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

The instructions may form an application program tangibly embodied on a processor-readable medium.

Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described example of the present principles, or to carry as data the actual syntax-values written by a described example of the present principles. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for determining an output value representing a picture data by applying a piece-wise linear function on an input value representing a picture data, said piece-wise linear function comprising at least one piece, said piece being characterized by a slope value ai, an offset value and an interval defined over a range of values comprised between a lower bound and an upper bound, wherein the method comprises:
obtaining a coded input value X coded with quantization on n bits;
obtaining a coded slope value Ai, said coded slope value Ai representing a mantissa value ai_m coded with m bits and an exponent of 2 value ai_e coded with (K−m) bits, K being the total number of bits to code said slope value aᵢ;
identifying the (K−m) most significant bits of the coded slope, said (K−m) most significant bits forming an exponent value aᵢ_{_}e of a decoded slope value;
identifying the m least significant bits of the coded slope value, said m least significant bits forming the mantissa aᵢ_{_}m of the decoded slope value;
determining the output value y by right shifting the integer value resulting from the product of the mantissa aᵢ_{_}m of the decoded slope and of the coded input data X by an integer value equal to (n+m−aᵢ_{_}e−p), where p is the number of quantization bits used to code the output value y; and
adding an offset value bᵢ.

2. The method of claim 1, wherein the mantissa aᵢ_{_}m of the decoded slope value is formed as aᵢ_{_}m=Aᵢ−(Ai>>(K−m))<<(K−m), where the operator << is the left shifting operator and >> is the right shifting operator of the binary representation of an integer.

3. The method of claim 2, wherein the exponent value aᵢ_{_}e of a decoded slope value is formed as aᵢ_{_}e=Aᵢ>>(K−m).

4. A method for determining an output value representing a picture data by applying a piece-wise linear function on an input value representing a picture data, said piece-wise linear function comprising at least one piece, said piece being characterized by a slope value a, an offset value and an interval defined over a range of values comprised between a lower bound and an upper bound, wherein the method comprises:
obtaining a coded input value X coded with quantization on n bits;
obtaining a coded slope value Aᵢ coded with quantization on m bits for an interval Ri which the input value belongs to;
determining the output value by shifting the product of the coded slope value Aᵢ and the coded input data X by an integer value equal to (n+m−p), where p is the number of quantization bits used to code the output value y; and
adding an offset value bᵢ.

5. The method of claim 4, wherein the coded slope value Ai is obtained by coding the slope value aᵢ by Aᵢ=Int(aᵢ*(1<<n)) when the slope value ai<1, and by Aᵢ=Int((1/aᵢ)*(1<<n)) when the slope value ai>1; and
the method further comprises:
signaling whether the slope of the first interval is lower than or greater than 1;
signaling the ending point of a current interval when:
the slope of a following interval become greater to 1 and the slope of the current interval is lower than 1; or
the slope of a following interval become lower than 1 and the slope of the current interval is greater to 1,
where the operator << is the left shifting operator and >> is the right shifting operator.

6. The method of claim 1, wherein the number of bits n is derived by n=Int(log 2 (Mᵢ−mᵢ)) where mi is a lower bound of the interval which the input value belongs to and Mi the upper bound of said interval.

7. An apparatus for determining an output value representing a picture data by applying a piece-wise linear function on an input value representing a picture data, said piece-wise linear function comprising at least one piece, each piece being characterized by a slope value ai, an offset value and an interval defined over a range of values comprised between a lower bound and an upper bound, wherein the apparatus comprises means for:
obtaining a coded input value X coded with quantization on n bits;
obtaining a coded slope value Ai, said coded slope value Ai representing a mantissa value ai_m coded with m bits and an exponent of 2 value ai_e coded with (K−m) bits, K being the total number of bits to code said slope value ai;
identifying the (K−m) most significant bits of the coded slope, said (K−m) most significant bits forming an exponent value aᵢ_{_}e of a decoded slope value;
identifying the m least significant bits of the coded slope value, said m least significant bits forming the mantissa aᵢ_{_}m of the decoded slope value;
determining the output value y by right shifting the product of the mantissa aᵢ_{_}m of the decoded slope and the coded input data X by an integer value equal to (n+m−aᵢ_{_}e−p), where p is the number of quantization bits used to code the output value y; and
adding an offset value bᵢ.

8. The apparatus of claim 7, wherein the mantissa aᵢ_{_}m of the decoded slope value is formed as aᵢ_{_}m=Aᵢ−(Aᵢ>>(K−m))<<(K−m), where the operator << is the left shifting operator and >> is the right shifting operator.

9. The apparatus of claim 8, wherein the exponent value aᵢ_{_}e of a decoded slope value is formed as aᵢ_{_}e=Aᵢ>>(K−m).

10. An apparatus for determining an output value representing a picture data by applying a piece-wise linear function on an input value representing a picture data, said piece-wise linear function comprising at least one piece, each piece being characterized by a slope value a, an offset value and an interval defined over a range of values comprised between a lower bound and an upper bound, wherein the apparatus comprises means for:
obtaining a coded input value X coded with quantization on n bits;
obtaining a coded slope value Aᵢ coded with quantization on m bits for an interval Rᵢ which the input value belongs to;
determining the output value by shifting the product of the coded slope value Aᵢ and the coded input data X by an integer value equal to (n+m−p), where p is the number of quantization bits used to code the output value y and adding an offset value bᵢ.

11. The apparatus of claim 10, wherein said meand for obtaining a coded slope value Aᵢ are configured to obtain the coded slope value Ai by coding the slope value aᵢ by Aᵢ=Int(aᵢ*(1<<n)) when the slope value ai<1, and by Aᵢ=Int((1/aᵢ)*(1<<n)) when the slope value ai>1; and the apparatus further comprises means for:
signaling whether the slope of the first interval is lower than or greater than 1;
signaling the ending point of a current interval when:
the slope of a following interval become greater to 1 and the slope of the current interval is lower than 1; or
the slope of a following interval become lower than 1 and the slope of the current interval is greater to 1.

12. (canceled)

13. A computer program product comprising program code instructions to execute the steps of the method according to claim 1 when this program is executed on a computer.

14. A processor readable medium having stored therein instructions for causing a processor to perform at least the steps of the method according to claim 1.

15. Non-transitory storage medium carrying instructions of program code for executing steps of the method according to claim 1, when said program is executed on a computing device.

16. A data carrier signal carrying the computer program product of claim 13.
